(19) United States
(12) Patent Application Publication
(10) Pub. No.: US 2026/0239359 A1
(43) Pub. Date: Aug. 13, 2026

(54) BIT PROCESSING IN WIRELESS COMMUNICATION SYSTEMS

(71) Applicant: Samsung Electronics Co., Ltd., Suwon-si (KR)

(72) Inventors: Saifur Rahman, Plano, TX (US); Eko Onggosanusi, Coppell, TX (US); Heping Wan, Plano, TX (US); Emad Nader Farag, Flanders, NJ (US)

(21) Appl. No.: 19/454,398

(22) Filed: Jan. 21, 2026

Related U.S. Application Data
(60) Provisional application No. 63/755,905, filed on Feb. 7, 2025.

(51) Int. Cl. H04W 72/21; H04B 7/06; H04L 1/1812; H04W 72/044; H04W 72/12

(52) U.S. Cl. CPC H04W 72/21; H04B 7/0626; H04L 1/1812; H04W 72/046; H04W 72/12

(57) ABSTRACT

Apparatuses and methods for bit processing in a wireless communication system. A method performed by a user equipment (UE) includes determining information bits, mapping the information bits to channel coding bits, determining an uplink (UL) transmission based on the channel coding bits, and performing the UL transmission. The mapping of the information bits to the channel coding bits is based on a distribution of the information bits and a reliability of the channel coding bits.

### CROSS-REFERENCE TO RELATED AND CLAIM OF PRIORITY

The present application claims priority under 35 U.S.C. § 119(e) to U.S. Provisional Patent Application No. 63/755,905 filed on Feb. 7, 2025, which is hereby incorporated by reference in its entirety.

### TECHNICAL FIELD

The present disclosure relates generally to wireless communication systems and, more specifically, the present disclosure is related to apparatuses and methods for bit processing in wireless communication systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to bit processing in wireless communication systems.

In one embodiment, a user equipment (UE) is provided. The UE includes a processor configured to determine information bits, map the information bits to channel coding bits, and determine an uplink (UL) transmission based on the channel coding bits. The UE further includes a transceiver operably coupled to the processor, the transceiver configured to perform the UL transmission. The mapping of the information bits to the channel coding bits is based on a distribution of the information bits and a reliability of the channel coding bits.

In another embodiment, a base station (BS) is provided. The BS includes a transceiver configured to receive an UL transmission and a processor operably coupled to the transceiver. The processor is configured to determine information bits based on channel coding bits included in the UL transmission. The mapping of the information bits to the channel coding bits is based on a distribution of the information bits and a reliability of the channel coding bits.

In yet another embodiment, a method performed by a UE is provided. The method includes determining information bits, mapping the information bits to channel coding bits, determining an UL transmission based on the channel coding bits, and performing the UL transmission. The mapping of the information bits to the channel coding bits is based on a distribution of the information bits and a reliability of the channel coding bits.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates example radio access network (RAN) configurations according to embodiments of the present disclosure;

FIG. 7 illustrates example bit and symbol level processing according to embodiments of the present disclosure;

FIG. 8 illustrates an example source block according to embodiments of the present disclosure;

FIG. 9 illustrates an example of a non-uniform distribution of amplitude coefficients according to embodiments of the present disclosure;

FIG. 10 illustrates an example antenna port layout according to embodiments of the present disclosure;

FIG. 11 illustrates a timeline of example spatial-domain (SD) units and frequency-domain (FD) units according to embodiments of the present disclosure;

FIG. 12 illustrates an example codebook according to embodiments of the present disclosure;

FIG. 13 illustrates an example artificial intelligence (AI)-native CSI configuration according to embodiments of the present disclosure;

FIG. 14 illustrates an example complex-values matrix/vector according to embodiments of the present disclosure;

FIG. 15 illustrates an example neural network based auto encoder according to embodiments of the present disclosure;

FIG. 16 illustrates an example source coding according to embodiments of the present disclosure;

FIG. 17 illustrates an example separate compression and coding according to embodiments of the present disclosure;

FIG. 18 illustrates an example joint source channel coding according to embodiments of the present disclosure;

FIG. 19 illustrates an example low density parity check (LDPC) coding according to embodiments of the present disclosure;

FIG. 20 illustrates an example bit processing chain according to embodiments of the present disclosure; and

FIG. 21 illustrates an example method performed by a UE in a wireless communication system according to embodiments of the present disclosure.

### DETAILED DESCRIPTION

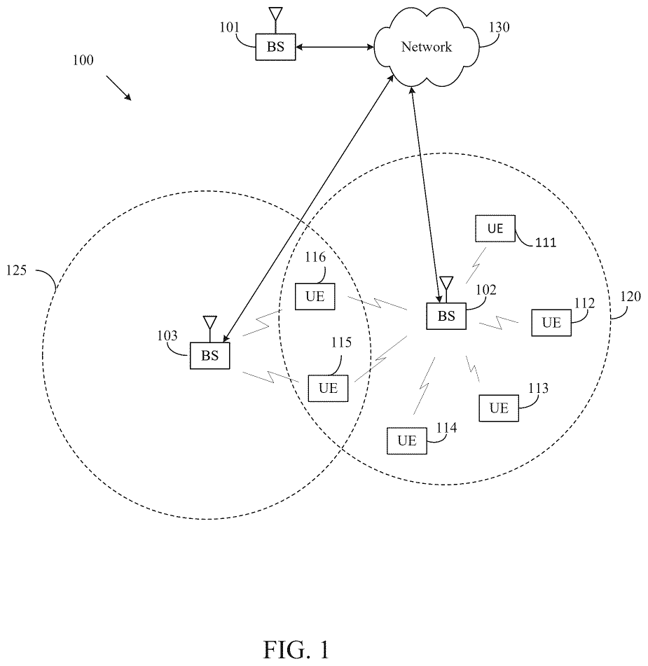

FIGS. 1-21 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP, TS 38.211, 5G; NR; Physical channels and modulation; [REF 2] 3GPP, TS 38.331, 5G; NR; Radio Resource Control (RRC); Protocol specification; [REF 3] 3GPP, TS 38.321, 5G; NR; Medium Access Control (MAC); Protocol specification; [REF 4] 3GPP, TS 38.214, 5G; NR; Physical layer procedures for data; [REF 5] https://mathworld.wolfram.com/ToeplitzMatrix.html; [REF 6] M. Wax and T. Kailath, “Efficient inversion of a doubly block Toeplitz matrix”, in Proc. IEEE ICASSP, pp. 170-173, Apr. 14-16, 1983; [REF 7] https://mathworld.wolfram.com/CirculantMatrix.html; [REF 8] A. Araujo, “Building Compact and Robust Deep Neural Networks with Toeplitz Matrices”, https://arxiv.org/pdf/2109.00959.pdf; [REF 9] 3GPP TS 38.212 v18.0.0, “E-UTRA, NR, Multiplexing and Channel coding;” [REF 10] 3GPP TS 38.213 v18.0.0, “E-UTRA, NR, Physical Layer Procedures for Control;” [REF 11] O-RAN.WG4.CONF.0-R003-v09.00, “O-RAN Working Group 4 (Fronthaul Working Group) Conformance Test Specification;” [REF 12] O-RAN.WG4.CUS.0-R003-v13.00, “O-RAN Working Group 4 (Open Fronthaul Interfaces WG)—Control, User and Synchronization Plane Specification.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for bit processing. In certain embodiments, one or more of the BSs 101-103 include circuitry, programing, or a combination thereof to support bit processing.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

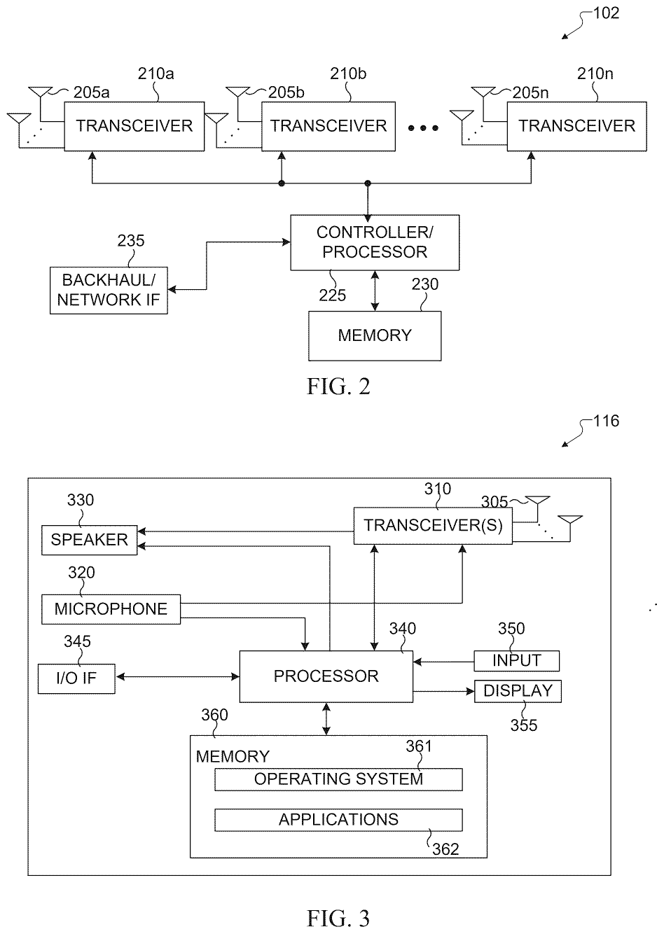

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for bit processing. Any of a wide variety of other functions could be supported in the gNB 102 by the controller/processor 225.

The controller/processor 225 is also capable of executing programs and other processes resident in the memory 230, such as processes to support bit processing. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for bit processing as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

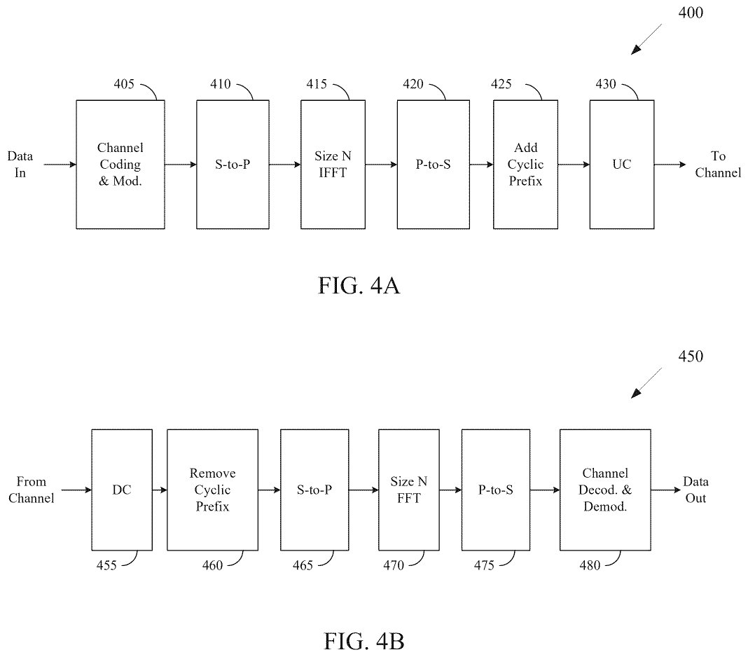

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for bit processing as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

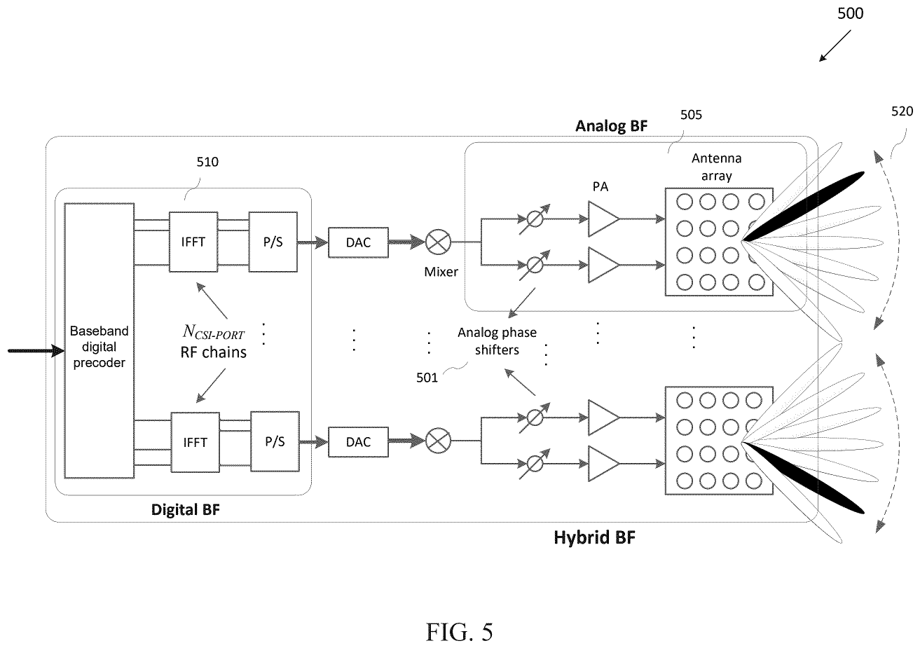

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports-which can correspond to the number of digitally precoded ports—can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In next generation cellular standards (e.g., 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

Likewise, for a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) or TRP is challenging due to a larger antenna form factor size needed evaluating carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiple user multiple-input-multiple-output (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 1. Whenever the FR2 is referred, both FR2-1 and FR2-2 frequency sub-ranges shall be provided, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g., 6G), in addition to FRI and FR2, new carrier frequency bands can be taken into account, e.g., terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

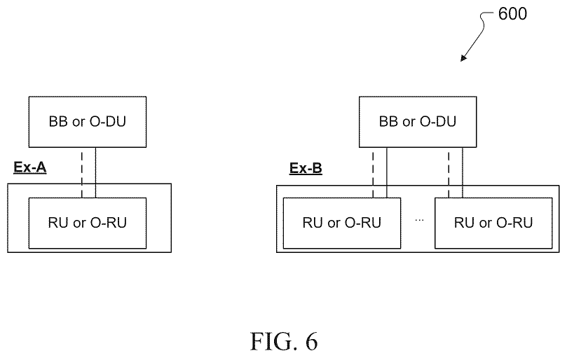

FIG. 6 illustrates a diagram of example RAN configurations 600 according to embodiments of the present disclosure. For example, RAN configurations 600 can be implemented by the BS 102 of FIG. 1. This example is for illustration only and other embodiments can be used without departing from the scope of the present disclosure.

Likewise, for O-RAN, a TRP can be functionally equivalent to (hence can be replaced with) or is interchangeable with one of more of the following:
One RU or O-RU: a logical node that includes a subset of the eNB/gNB functions (e.g., as listed in clause 4.2 split option 7-2×)
More than one RUs or O-RUs
One or more than one RUs or O-RUs

Two examples are shown in FIG. 6.

The following are defined in [REF11 and REF12].

| | |
|---|---|
| O-CU | O-RAN Central Unit - a logical node hosting PDCP, RRC, |
| | SDAP and other control functions |
| O-DU | O-RAN Distributed Unit: a logical node hosting RLC/MAC/ |
| | High-PHY layers based on a lower layer functional split. |
| | O-DU in addition hosts an M-Plane instance. |
| O-RU | O-RAN Radio Unit: a logical node hosting Low-PHY layer and |
| | RF processing based on a lower layer functional split. This is |
| | similar to 3GPP's “TRP” or “RRH” but more |
| | specific in including the Low-PHY layer (FFT/iFFT, PRACH |
| | extraction). O-RU in addition hosts M-Plane instance. |

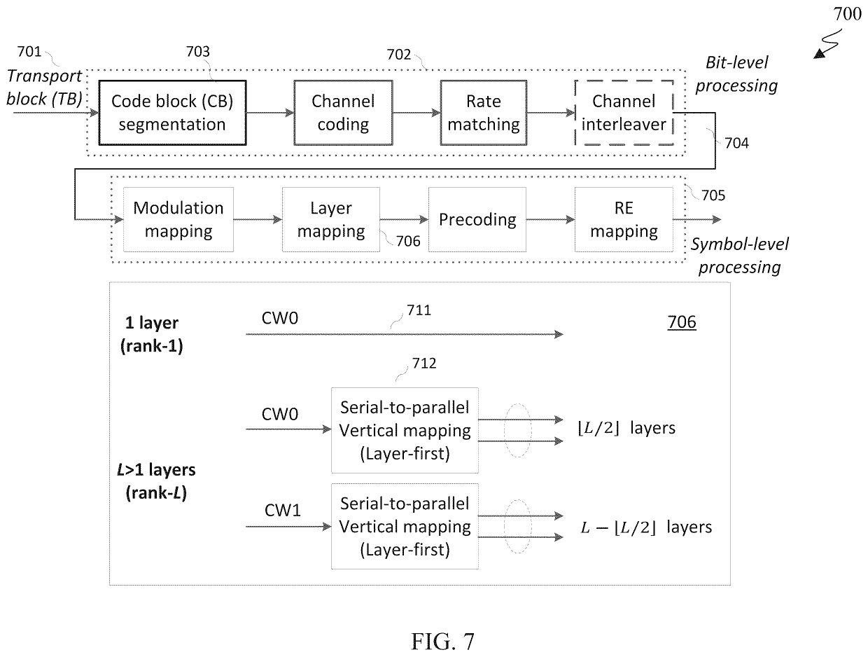

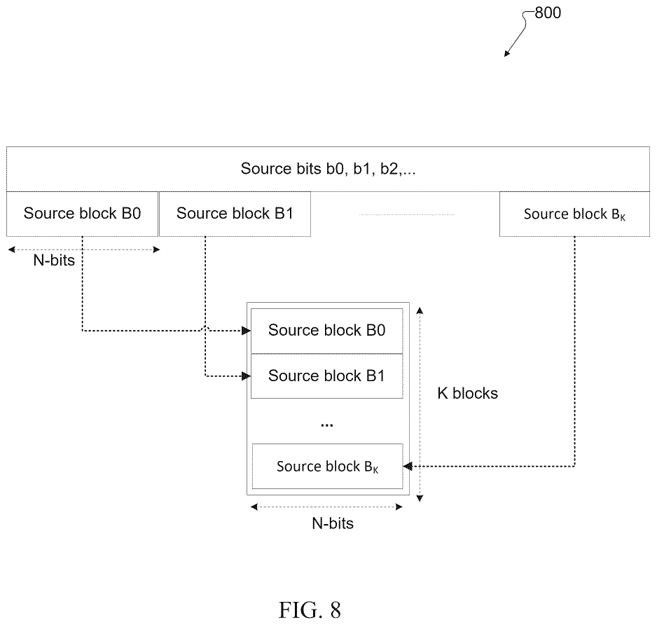

FIG. 7 illustrates example bit and symbol level processing 700 according to embodiments of the present disclosure. For example, bit and symbol level processing 700 can be utilized by any of the UEs 111-116 of FIG. 1, such as the UE 116. This example is for illustration only and other embodiments can be used without departing from the scope of the present disclosure

As shown in FIG. 7, a transport block (TB) 701 is processed by the following series of bit-level operations 702: code block (CB) segmentation (step 703), channel coding, rate matching, and channel interleaver (only for UL). For CB segmentation, a length-L_{TB} TB is segmented into C≥1 CBs if L_{TB}>6144. If C=1, only a 24-bit TB-CRC is inserted. If C>1, a 24-bit TB-CRC is first added before CB segmentation, followed by the insertion of a 24-bit CB-CRC at the end of each CB. Therefore, for C>1, both TB-CRC and CB-CRC are inserted. Note that TB-CRC and CB-CRC have different generating polynomials. To minimize the number of filler bits, up to two values of CB length K⁺ and K₋ are used. Therefore, in most cases when C>1, some CBs can be of length-K₋ while the others of length-K⁺. For channel coding, a set of allowable CB lengths (defined for Turbo QPP interleaver) are used with rate-1/3 Turbo code (PCCC) with 8-state constituent encoders. Since Turbo code is based on convolutional code, it does not have a built-in error detection capability. For rate matching, equal interleaving & puncturing for each of 3 Turbo output streams. This is achieved using 3 identical rectangular sub-block interleavers (one interleaver per Turbo output stream), bit collection followed by bit selection/pruning via circular buffer, and CB concatenation to form codeword (CW).

The output of bit-level processing 704, associated with one TB and one CW, is then processed by the following series of symbol-level operations 705: modulation mapping, layer mapping (706), precoding, and RE mapping. Depending on the number of transmission layers, a maximum of two codewords are used for DL and UL data transmissions (on DL data channel such as PDSCH or PDCH, and UL data channel such as PUSCH or PUCH, respectively) for spatial multiplexing as illustrated in embodiment 706 of FIG. 7 (cf. TABLE 5.3.2A-1-2 and 6.3.3.2-1 of REF1 for UL and DL, respectively). Layer mapping 706 maps 1 CW or 2 CWs to L layers before precoding 702. For L=1, one CW is mapped to one layer (711). For L>1, each of the two CWs is mapped to at least one layer (712) where L layers are divided almost evenly across the two CWs. In addition, one CW can also be mapped to >1 layers especially when only one of the two CWs is to be retransmitted.

FIG. 8 illustrates an example source block 800 according to embodiments of the present disclosure. For example, source block 800 can be utilized by any of the UEs 111-116 of FIG. 1, such as the UE 116. This example is for illustration only and other embodiments can be used without departing from the scope of the present disclosure.

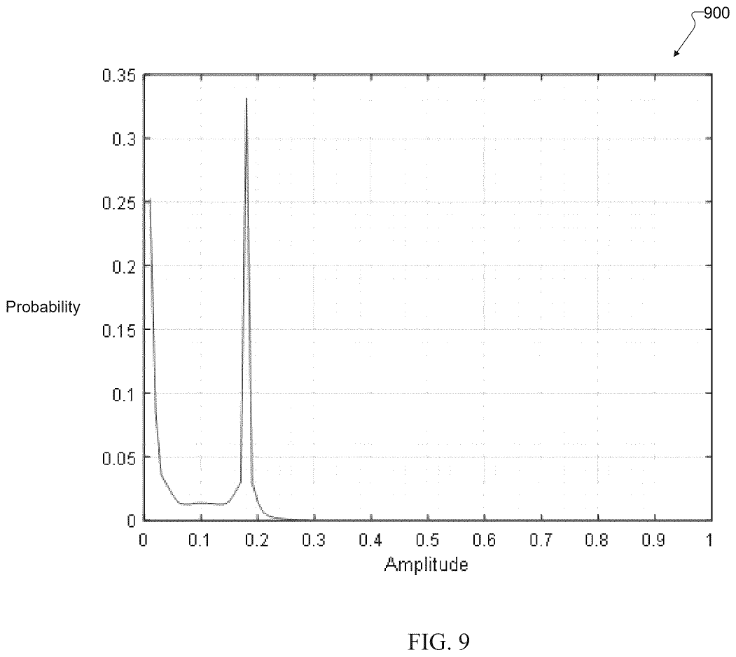

FIG. 9 illustrates an example of a non-uniform distribution of amplitude coefficients 900 according to embodiments of the present disclosure. For example, the non-uniform distribution of amplitude coefficients 900 can be utilized by any of the UEs 111-116 of FIG. 1, such as the UE 116. This example is for illustration only and other embodiments can be used without departing from the scope of the present disclosure.

In 4G LTE and 5G NR, source bits (UCI, DCI, or data) and channel coding bits are treated independently, i.e., the source bits undergo channel coding and modulation uniformly assuming each source bit (or source block) being equally probable and equally important. In order words, the channel coding is separate and agnostic to any information about the source bits (of blocks). In reality, however, the source bits (or blocks), in particular, UCI bits are likely to have a non-uniform probability distribution, either at a per-bit level or at a source-block level, wherein in latter, each source block comprises N consecutive source bits from a sequence of source bits, as illustrated in FIG. 8. The source bits b₀b₁b₂, . . . can be partitioned into source blocks B₀B₁B₂, . . . where each source block comprises N consecutive source bits. An example of a non-uniform distribution of amplitude coefficients based on 5G NR Rel-16 enhanced Type II codebook I is shown in FIG. 9. As is evident, amplitude coefficient=0.18 is the most probable, followed by amplitude coefficient=0.2, followed by values in between [0.2, 1.8], and values>0.2 have very small decaying probability.

This information can be exploited in channel coding. For example, the most important (probable) source bits or source blocks can be provided with a maximum reliability or protection against decoding errors. This can be achieved by mapping source bit(s) or block(s) to channel coding bits or blocks according to their (relative) importance or probability of occurrence. In other words, this essentially is an example of joint source channel coding scheme. This disclosure focusses on several examples of such schemes.

Embodiments of the present disclosure recognize that 5G NR does not exploit the non-uniform distribution of input bit sequences (e.g., UCI bits, data bits), and assumes a uniform distribution while performing the channel coding. In reality, however, at least for UCI bits, the distribution of UCI parameters and their corresponding bit-level representations exhibit correlation, hence non-uniform distribution. This can be exploited in 6G.

Accordingly, embodiments of the present disclosure describe several examples for compression and coding of UCI and data bit sequences. Details on the support of these methods/schemes for generating/reporting CSI are disclosed, including information elements to be exchanged between a transmitter and a receiver. The following aspects are provided in the disclosure:
Mapping and de-mapping before encoding and after decoding in the bit-processing chain of the communication protocol
Examples of mapping
Examples of coding schemes

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with My subbands when one CSI parameter is reported for each of the Mₙ subbands within the CSI reporting band.

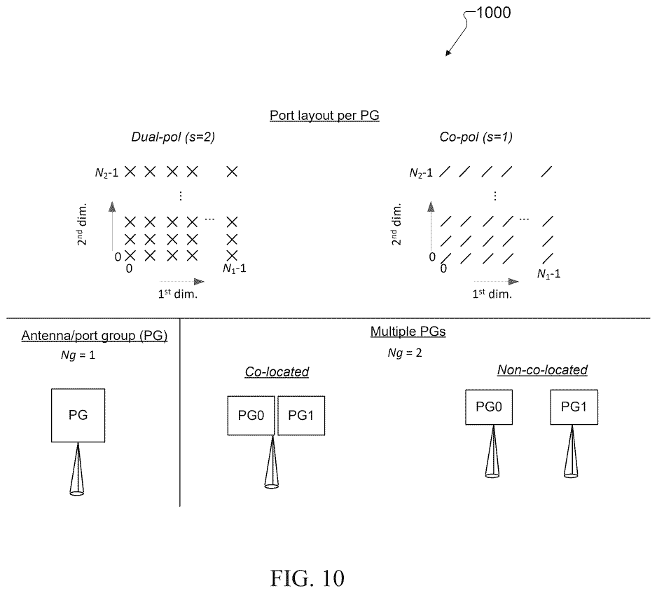

FIG. 10 illustrates an example antenna port layout 1000 according to embodiments of the present disclosure. For example, antenna port layout 1000 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either have N₁>1 and N₂=1 or N₂>1 and N₁=1. In the rest of the disclosure, 1D antenna port layouts with N₁>1 and N₂=1 is taken into account. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 10 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

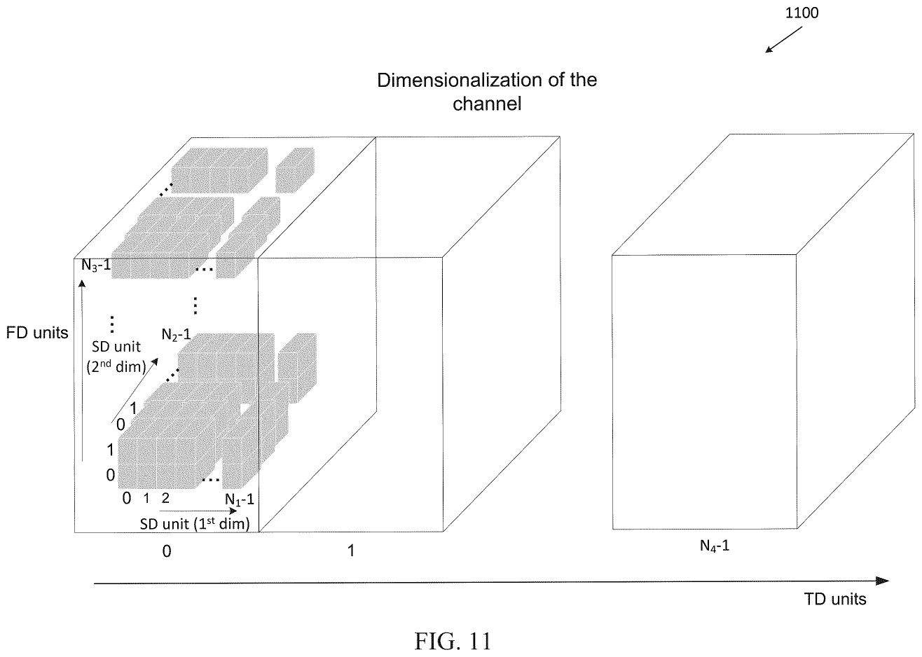

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 11. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g., comprising a CSI-RS resource set).

In one example, an antenna/port group corresponds to a reconfigurable intelligent surface (RIS) in which the antenna/port group can be (re-)configured more dynamically (e.g., via MAC CE or/and downlink control information (DCI)). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 10. The antenna structure at each PG or O-RU (or RU) can be the same. Or the antenna structure at an PG or O-RU (or RU) can be different from another PG or O-RU (or RU). Likewise, the number of ports at each PG (OR O-RU OR RU) can be the same. Or the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is provided in the rest of the disclosure. For simplicity, each PG (OR O-RU OR RU) is equivalent to a panel (cf. FIG. 10), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one embodiment, an PG (OR O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g., an RRC parameter). Or it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CQI report interval (CRI) or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

FIG. 11 illustrates a timeline 1100 of example SD units and FD units according to embodiments of the present disclosure. For example, timeline 1100 can be followed by any of the UEs 111-116 of FIG. 1, such as the UE 116. This example is for illustration only and other embodiments can be used without departing from the scope of the present disclosure.

The channel measurement can be based on K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 11.
The first dimension is associated with the 1st antenna port dimension and comprises N1 units,
The second dimension is associated with the 2nd antenna port dimension and comprises N2 units,
The third dimension is associated with the frequency dimension and comprises N3 units, and
The fourth dimension is associated with the time/Doppler dimension and comprises N4 units.
Alternatively, the SD units, FD units, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g., co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG or O-RU (or RU) comprising P_{CSIRS} ports, and the CSI report is based on the channel measurement from the one PG or O-RU (or RU).
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG or O-RU (or RU) (one-to-one mapping). In one example, multiple CMRs can correspond to an PG or O-RU (or RU) (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g., via higher layer RRC parameter. Or it can be indicated via a MAC CE. Or it can be provided via a DCI field.

Likewise, the value of K can be configured, e.g., via higher layer RRC parameter. Or it can be indicated via a MAC CE. Or it can be provided via a DCI field.

In one example, K=N_{g}=X. The value of X can be configured, e.g., via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

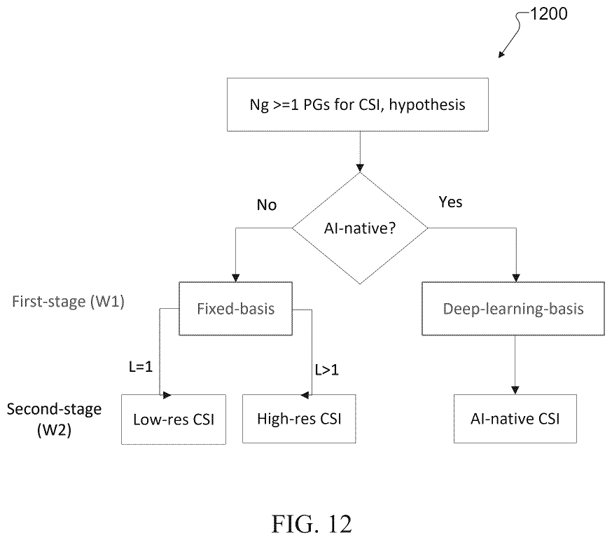

FIG. 12 illustrates an example codebook 1200 according to embodiments of the present disclosure. For example, codebook 1200 can be utilized by any of the UEs 111-116 of FIG. 1, such as the UE 112. This example is for illustration only and other embodiments can be used without departing from the scope of the present disclosure.

As discussed herein, a fixed codebook (expecting a uniform array and phase wave-front) is no longer sufficient in 6G due to (1) ‘new’ antenna types/architectures/geometries, (2) distributed (e.g., CJT), open (e.g., O-RAN), and “less”-structured (e.g., dynamic port adaptation for energy saving) NW topology, (3) dynamic duplexing (e.g., subband full duplex (SBFD), single frequency full duplex (SFFD)) operations, and advanced technologies such as RIS and near-field effects, and (4) new frequency bands with sparser (low-rank) channels (e.g., FR3) requiring mTRP-like MIMO operations. These necessitate a scenario-driven learning-based codebook-design. AI-native could be instrumental in this regard. For a UE not capable of AI-native, the fixed-basis codebook can be used as a last resort as illustrated in FIG. 12.

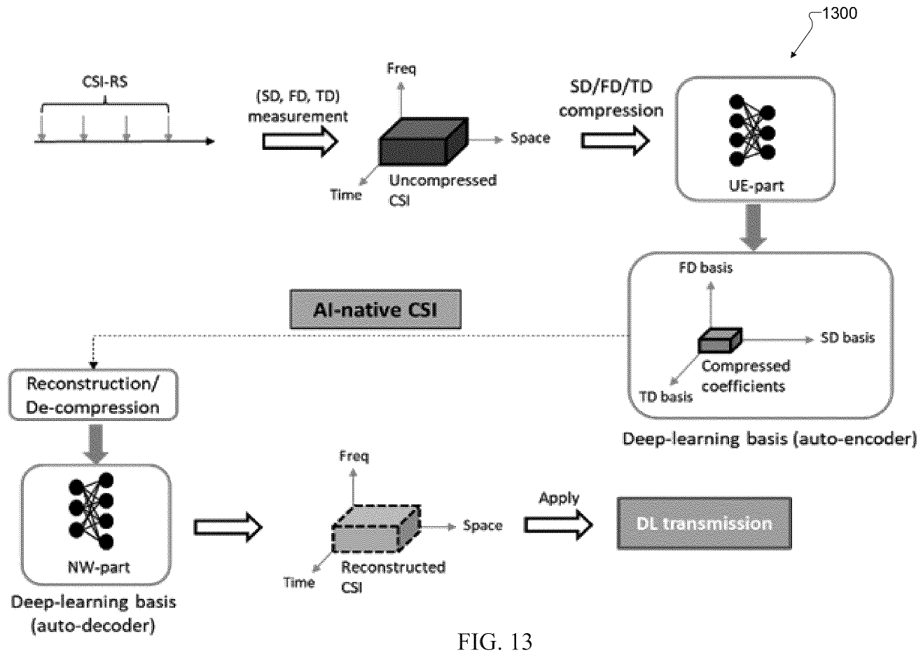

FIG. 13 illustrates an example AI-native CSI configuration 1300 according to embodiments of the present disclosure. For example, the UE 113 and the network 130 and/or the BS 103 of FIG. 1 can implement AI-native CSI configuration 1300. This example is for illustration only and other embodiments can be used without departing from the scope of the present disclosure.

In an example of AI-native CSI, the precoding is based on two stages: (i) first-stage for basis (W1) and (ii) second-stage for coefficients (W2). The first-stage includes a deep-learning-based basis, if the user is AI-native capable, and a unified fixed-basis, otherwise. The fixed-basis can also be used for fallback, initialization. An illustration of the AI-native CSI is shown in FIG. 13. The user measures CSI-RS and uses the measurement to determine uncompressed CSI. The CSI is then compressed in (SD, FD) or (SD, FD, DD), if DD compression is ON, utilizing the deep-learning-basis (auto-encoder). The compressed coefficients are then fed back as part of the AI-native CSI report. The deep-learning auto-decoder is then used to de-compress or reconstruct the CSI, which then is applied to subsequent downlink (DL) transmissions. The details of fixed- and deep-learning bases are provided next.

As antenna geometries get less-structured or more-distributed, (SD, FD, TD) properties can no longer be quantified with only fixed-basis, they rather need to be learnt depending on scenarios and deployments. Here, (SD, FD, TD) properties include antenna geometry, compression dimensions, SD/FD/TD units, prediction, and second order channel statistics. One can adopt a learning-based basis that replaces the fixed-basis. In one example, the learning-based basis can have some structure such as a convolutional (CNN)-based deep-learning basis. In one example, the learning-based basis is unstructured such as a fully connected deep (linear) layer. Mathematically, a one-dimensional (1D) operation is equivalent to: A=KH_{data}, where K is a learning-basis matrix and H_{data} is a data matrix, e.g., channel eigenvector matrix with columns being eigenvectors for N_{SB} SBs. For 2D (e.g., SD and FD), we can have two separate 1D bases, one for each dimension. Two separate 1D convolutions is equivalent to:

$$A = {K}_{S D}^{H} {H}_{d a t a} {K}_{F D} ,$$

where K_{SD} and K_{FD} are basis matrices for SD and FD, respectively. The matrix K or matrices (K_{SD}, K_{FD}) can be constructed based on a Kernel (basis) B.

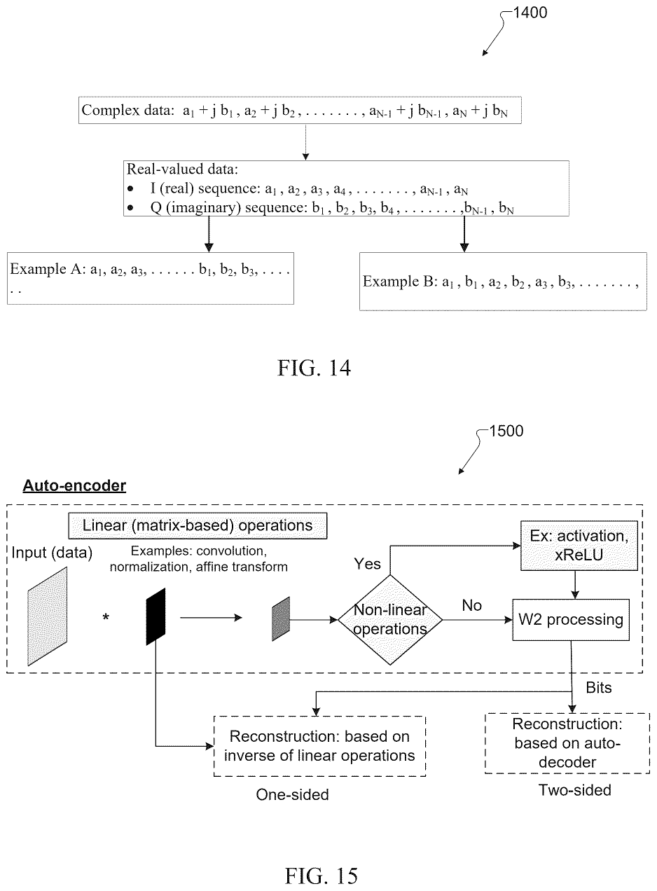

FIG. 14 illustrates an example complex-values matrix/vector 1400 according to embodiments of the present disclosure. For example, complex-values matrix/vector 1400 can be utilized by any of the UEs 111-116 of FIG. 1, such as the UE 116. This example is for illustration only and other embodiments can be used without departing from the scope of the present disclosure.

In one example, the input X=H_{data} is a complex-valued matrix (or vector). In one example, the input X is a real-valued matrix (or vector), which is formed by concatenation of real and imaginary parts of complex data values. At least one of the following examples shown in FIG. 14 is used for the concatenation.

FIG. 15 illustrates an example neural network based auto encoder 1500 according to embodiments of the present disclosure. For example, the UE 116 of FIG. 3 can be configured to use the neural network based auto encoder 1500. This example is for illustration only and other embodiments can be used without departing from the scope of the present disclosure.

In one embodiment, as shown in FIG. 15, a UE (e.g., the UE 116) is configured to use a neural network (NN)-based auto-encoder (AE) model to determine a CSI, where the CSI is based on compression in at least one of SD, FD, and DD. The AE takes an input (data), e.g., eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI.

In one embodiment, the model for CSI compression is one-sided, i.e., AE only. That is, there is no associated NN-based auto-decoder (AD) needed at the gNB (e.g., the BS 102) to reconstruct the CSI. In one example, the one-sided model is downloadable, hence can be referred to as a downloadable codebook.

In one embodiment, a UE is configured to use a neural network (NN)-based two-sided model comprising an auto-encoder (AE) part and an auto-decoder (AD) part. The AE part of the model is used to determine a CSI, where the CSI is based on compression in at least one of SD, FD, and DD. The AE takes an input (data), e.g., eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW as input to the AD part of the model. The output of the AD part corresponds to a reconstructed CSI.

The rest of the disclosure focusses on CSI compression, UCI multiplexing, and channel coding considering unequal error protection (reliability) to some of the information bits over the other.

In one embodiment, a method for a UE is proposed wherein the method comprises representing (source coding) more probable (with higher probability) information bit(s) with smaller number of compressed bit(s), and then mapping/ordering the compressed bit(s) to more reliable (or more protected against channel variations) portion of the (channel) coded bit(s), thereby, performing a joint (source) compression of information bits and (channel) coding for reliable communication.

Let I_{N} be a bit sequence of length N (aka source block). In one example, the bit sequence comprises UL control (e.g., UCI) bits. In one example, the bit sequence comprises UL data (e.g., packets/blocks or CW) bits. In one example, the UCI bits can include HARQ-ACK or/and SR or/and CSI. In one example, the UCI bits include CSI only.

In one example, N∈S where the set S comprises values greater than one. The value of N can be fixed. Or, the value of N is configured to a UE (e.g., via RRC or/and MAC CE or/and DCI, or a system message such as SIB1). Or, the value of N is determined by the UE, and reported by the UE to the NW. For example, this reporting can be a part of the UE capability information or/and a part of the CSI. When the CSI is a two-part CSI (multiplexed on a two-part UCI), part 1 CSI can include an information about the value of N.

In one example, the value of N can be determined based on a metric. In one example, the metric is based on the entropy of the distribution of all possible length N bit sequences over 2^{N}-dimensional orthants (or Euclidean space).

In one example, the distribution of length-N bit sequences (or source blocks) I_{N} is determined according to at least one of the following examples.
In one example the distribution is determined by the NW (or a NW-side entity such as a NW-sided OTT server) and is transferred/configured to the UE (e.g., via RRC or/and MAC CE or/and DCI, or a system message such as SIB1). Here, OTT refers to over-the-top.
In one example, the distribution is determined by the UE (or a UE-side entity such as a UE-sided OTT server). An information about the determined distribution can be reported by the UE to the NW. This reporting can be via a layer 1 physical channel (e.g., such as PUCCH or/and PUSCH or/and PRACH), or higher layer message (e.g., such as UL MAC CE or/and RRC).
In one example the distribution is determined by an entity other than UE and NW. The entity can be a server (e.g., OTT). An information about the determined distribution can be transferred to the UE or/and the NW.

In one example, the data for determining distribution is acquired according to at least one of the following examples.
In one example, the data is acquired based on layer 1 DL measurements. In one example, at least one DL RS is used for this purpose. The at least one DL RS can be NZP CSI-RS, SSB, or DL DMRS, or a dedicated/new DL RS for this purpose.
In one example, the data is acquired based on layer 1 UL measurements. In one example, at least one UL RS is used for this purpose. The at least one DL RS can be SRS, or UL DMRS, or a dedicated/new UL RS for this purpose.
In one example, the data is acquired based on layer 2 DL measurements. In one example, the DL DMRS or DL PDSCH associated with DL MAC CE is used for this purpose.
In one example, the data is acquired based on layer 3 DL measurements. In one example, the DL DMRS or DL PDSCH associated with DL RRC message is used for this purpose.
In one example, the data is acquired based on layer 2 UL measurements. In one example, the UL DMRS or UL PUSCH associated with UL MAC CE is used for this purpose.
In one example, the data is acquired based on layer 3 UL measurements. In one example, the UL DMRS or UL PUSCH associated with UL RRC message is used for this purpose.
In one example, the data is acquired based on a combination at least two of the above examples.

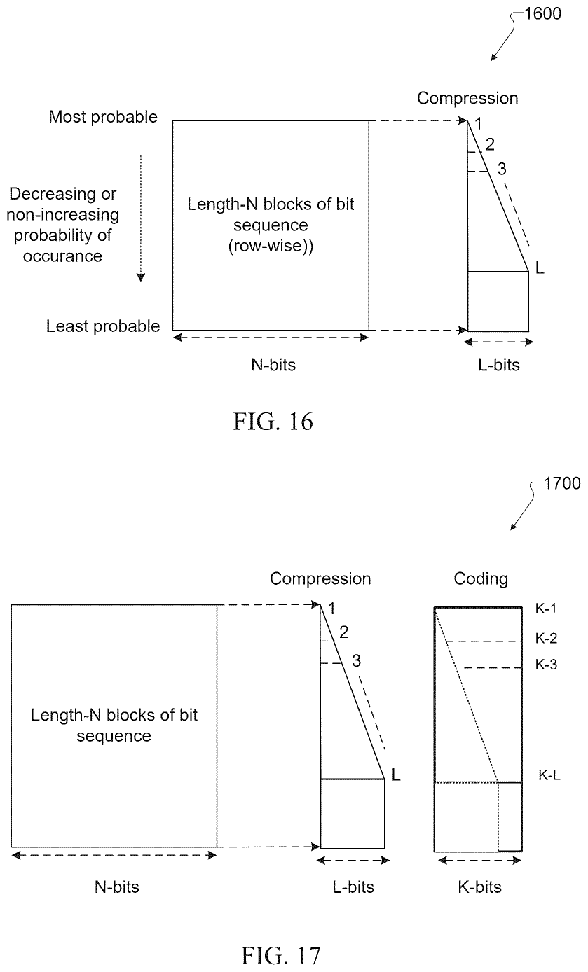

FIG. 16 illustrates an example source coding 1600 according to embodiments of the present disclosure. For example, the UE 116 of FIG. 3 can be configured to use the example source coding 1600. This example is for illustration only and other embodiments can be used without departing from the scope of the present disclosure.

In one embodiment, a set of length-N blocks of bit sequences can be sorted/ordered according to their probability distribution, an example of which is shown in FIG. 16. The number of all possible of length-N bit sequences is 2^{N}. The most probable (with the highest probability) among then corresponds to the top row, and bit sequences are placed/ordered in decreasing or non-increasing probability of their occurrences from top row to the bottom (last) row corresponding to the least probable bit sequence. To compress, each row n can be represented by (or coded as) kₙ bits where the value of kₙ increases as the probability increases. An example is illustrated in Table 2 which is an example of lossless ‘source coding’ based on variable length (VL) or unequal length (UL) codes (or sequences). When the codes comprise binary {0,1} values, the coding can correspond to Huffman coding. When the codes comprise real values/numbers between 0 and 1, the coding can correspond to arithmetic coding.

TABLE 2

| Bit sequence | Compression | | Coding | |
|---|---|---|---|---|
| Index n | kₙ (number of bits) | Binary representation | Number of bits | Codeword portion |
| 0 | 1 | 0 | K − 1 | ${a}_{0}^{0} … {a}_{K - 1}^{0}$ |
| 1 | 2 | 01 | K − 2 | ${a}_{0}^{1} … {a}_{K - 2}^{1}$ |
| 2 | 3 | 001 | K − 3 | ${a}_{0}^{2} … {a}_{K - 3}^{2}$ |
| 3 | 4 | 0001 | K − 4 | |
| . . . | . . . | . . . | . . . | |
| 2^{N} − 1 | . . . | 0000 . . . 1 | K = L | ${a}_{0}^{{2}^{N} - 1} … {a}_{K - L}^{{2}^{N} - 1}$ |

FIG. 17 illustrates an example separate compression and coding 1700 according to embodiments of the present disclosure. For example, the UE 116 of FIG. 3 can be configured to use the example separate compression and coding 1700. This example is for illustration only and other embodiments can be used without departing from the scope of the present disclosure.

Since the distribution of length-N bit sequences is non-uniform (or unequal), the bit sequences after compression (or source coding) can be protected against channel variations accordingly, i.e., the most probable bit sequence or the corresponding (source) code is protected the most, e.g., by assigning it to the most reliable portion of the (channel) coding. In one example, the most reliable portion of the channel coding bits corresponds to the portion that has the highest probability of error detection and correction (when there is a decoding error due to channel variations). Akin to (source) coding, the length-N bit sequences after compression can be protected against channel variations by mapping/assigning/them to portions of the channel coding (CW) blocks according to their probabilities. This is illustrated in FIG. 17 and Table 2 where a kₙ-bit (source) code after compression is assigned (K−kₙ) additional bits resulting in a total of K-bit portion of the channel codeword for the reliable communication over the channel. Since kₙ varies with n, the number of reliability bits also varies. The overall coding rate is (N to kₙ source code and kₙ to K channel code).

In one embodiment, as shown in Table 3, a length-N block of bit sequence (with index n) can be compressed and coded jointly by mapping it to a codeword (CW) of length K such that (i) a first portion of the CW

$${b}_{0}^{n} … {b}_{{k}_{n} - 1}^{n} ,$$

effectively can be associated with the compression (i.e., information bits before coding), and (ii) a second portion of the CW,

$${a}_{0}^{n} … {a}_{K - {k}_{n}}^{n} ,$$

effectively can be associated with the coding (i.e., reliability bits), hence achieving

$$\frac{N}{{k}_{n}}$$

compression and

$$\frac{{k}_{n}}{K}$$

coding (reliability) rate. In one example, the mapping of the length-N block of bit sequence to the CW is based on the distribution (probability or likelihood of occurrence) of the bit sequence among ot out of all possible bit sequence of the same length. For example, the sequence with index n can be effectively compressed to kₙ bits where the value of kₙ is inversely proportional to the probability of the occurrence of the sequence.

TABLE 3

| | Joint compression and coding | | | |
|---|---|---|---|---|
| Bit sequence | Reliability | # information bits | # coding | |
| Index n | rate | kₙ | bits | Codeword portion |
| 0 | $\frac{1}{K}$ | 1 | K − 1 | ${b}_{0}^{0} {a}_{0}^{0} … {a}_{K - 1}^{0}$ |
| 1 | $\frac{2}{K}$ | 2 | K − 2 | ${b}_{0}^{1} {b}_{1}^{1} {a}_{0}^{1} … {a}_{K - 2}^{1}$ |
| 2 | $\frac{3}{K}$ | 3 | K − 3 | ${b}_{0}^{2} {b}_{1}^{2} {b}_{2}^{2} {a}_{0}^{2} … {a}_{K - 3}^{2}$ |
| 3 | $\frac{4}{K}$ | 4 | K − 4 | |
| . . . | . . . | . . . | . . . | |
| 2^{N} − 1 | $\frac{L}{K}$ | . . . | K − L | ${b}_{0}^{{2}^{N} - 1} … {b}_{L - 1}^{{2}^{N} - 1} {a}_{0}^{{2}^{N} - 1} … {a}_{K - L - 1}^{{2}^{N} - 1}$ |

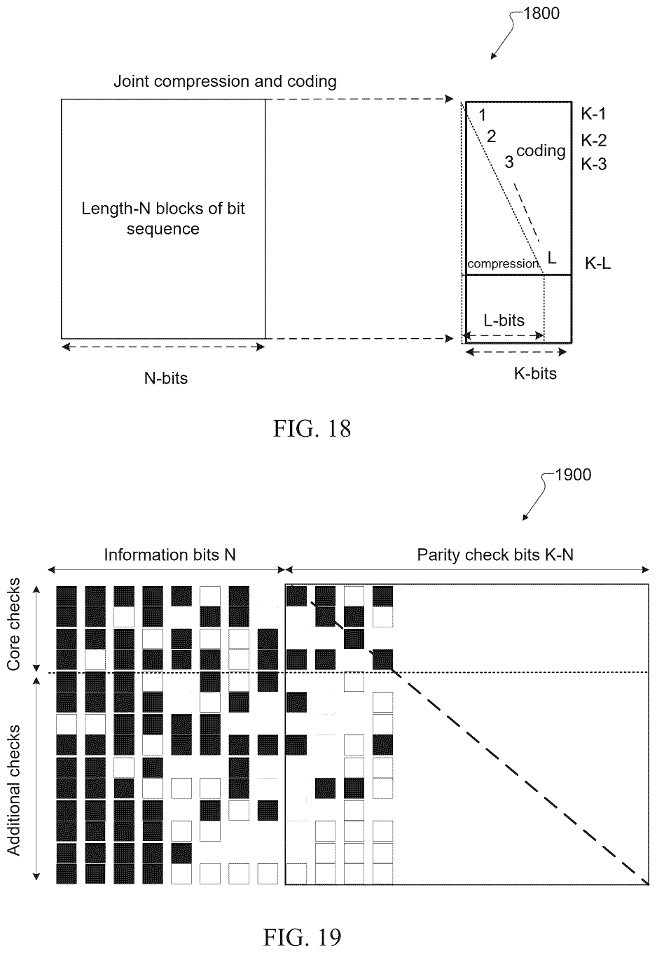

FIG. 18 illustrates an example joint source channel coding 1800 according to embodiments of the present disclosure. For example, the UE 116 of FIG. 3 can be configured to use the example joint source channel coding 1800. This example is for illustration only and other embodiments can be used without departing from the scope of the present disclosure.

Since the distribution of length-N bit sequences is non-uniform (or unequal) in general, the bit sequences can be mapped to the CW accordingly, i.e., the most probable bit sequence is protected the most, e.g., by assigning it to the most reliable portion of the (channel) coding. In one example, the most reliable portion of the channel coding bits corresponds to the portion that has the highest probability of error detection and correction (when there is a decoding error due to channel variations). This can be achieved by mapping/assigning/them to portions of the channel coding (CW) blocks according to their probabilities. This is illustrated in FIG. 18. As we move from top to bottom in the figure, both compression and reliability decreases since the effective number of compressed information bits increases 1, 2, . . . , L, and the effective number of reliability bits decreases K−1, K−2, . . . , K−L.

In 5G NR, different channel coding schemes are used for UCI (UL control) and UL data, or DCI (DL control) and DL data. In particular, a polar (or block) coding is used for UCI, and a LDPC coding is used for UL data. Both polar and LDPC coding schemes can provide unequal error protection or non-uniform/unequal reliability on the information of data bits. In one example, the coding in embodiments or examples described earlier are based on polar coding. In one example, the coding in embodiments or examples described earlier are based on LDPC coding. In one example, the coding in embodiments or examples described earlier are based on polar or/and LDPC coding. In one example, the coding in embodiments or examples described earlier are based on turbo coding.

For polar code, MSBs of the coded bits (comprising a CW) are the most reliable and LSBs are the least. In particular, as described in 5.3.1.2 of TS 38.212, the Polar sequence

$${Q}_{0}^{{N}_{max} - 1} = \{ {Q}_{0}^{{N}_{max}} , {Q}_{1}^{{N}_{max}} , … , {Q}_{{N}_{max} - 1}^{{N}_{max}} \}$$

is given by Table 5.3.1.2-1 of TS 38.212 (copies below), where

$$0 \leq {Q}_{i}^{{N}_{max}} \leq {N}_{max} - 1$$

denotes a bit index before Polar encoding for i=0, 1, . . . , Nₘₐₓ−1 and Nₘₐₓ=1024. The Polar sequence

$${Q}_{0}^{{N}_{max} - 1}$$

is in ascending order of reliability

$$W ( {Q}_{0}^{{N}_{max}} ) < W ( {Q}_{1}^{{N}_{max}} ) < … < W ( {Q}_{{N}_{max} - 1}^{{N}_{max}} ) ,$$

where

$$W ( {Q}_{i}^{{N}_{max}} )$$

denotes the reliability of bit index

$${Q}_{i}^{{N}_{max}} .$$

In one example, the mapping of information bits to coding bits, as proposed earlier in the disclosure, is according to the reliability order of the polar code, as specified in 5G NR specification TS 38.212.

TABLE 5.3.1.2-1
$Polar sequence {Q}_{0}^{{N}_{max} - 1} and its corresponding reliability W ( {Q}_{i}^{{N}_{max}} )$

| $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ |
|---|---|---|---|---|---|---|---|
| 0 | 0 | 128 | 518 | 256 | 94 | 384 | 214 |
| 1 | 1 | 129 | 54 | 257 | 204 | 385 | 309 |
| 2 | 2 | 130 | 83 | 258 | 298 | 386 | 188 |
| 3 | 4 | 131 | 57 | 259 | 400 | 387 | 449 |
| 4 | 8 | 132 | 521 | 260 | 608 | 388 | 217 |
| 5 | 16 | 133 | 112 | 261 | 352 | 389 | 408 |
| 6 | 32 | 134 | 135 | 262 | 325 | 390 | 609 |
| 7 | 3 | 135 | 78 | 263 | 533 | 391 | 596 |
| 8 | 5 | 136 | 289 | 264 | 155 | 392 | 551 |
| 9 | 64 | 137 | 194 | 265 | 210 | 393 | 650 |
| 10 | 9 | 138 | 85 | 266 | 305 | 394 | 229 |
| 11 | 6 | 139 | 276 | 267 | 547 | 395 | 159 |
| 12 | 17 | 140 | 522 | 268 | 300 | 396 | 420 |
| 13 | 10 | 141 | 58 | 269 | 109 | 397 | 310 |
| 14 | 18 | 142 | 168 | 270 | 184 | 398 | 541 |
| 15 | 128 | 143 | 139 | 271 | 534 | 399 | 773 |
| 16 | 12 | 144 | 99 | 272 | 537 | 400 | 610 |
| 17 | 33 | 145 | 86 | 273 | 115 | 401 | 657 |
| 18 | 65 | 146 | 60 | 274 | 167 | 402 | 333 |
| 19 | 20 | 147 | 280 | 275 | 225 | 403 | 119 |
| 20 | 256 | 148 | 89 | 276 | 326 | 404 | 600 |
| 21 | 34 | 149 | 290 | 277 | 306 | 405 | 339 |
| 22 | 24 | 150 | 529 | 278 | 772 | 406 | 218 |
| 23 | 36 | 151 | 524 | 279 | 157 | 407 | 368 |
| 24 | 7 | 152 | 196 | 280 | 656 | 408 | 652 |
| 25 | 129 | 153 | 141 | 281 | 329 | 409 | 230 |
| 26 | 66 | 154 | 101 | 282 | 110 | 410 | 391 |
| 27 | 512 | 155 | 147 | 283 | 117 | 411 | 313 |
| 28 | 11 | 156 | 176 | 284 | 212 | 412 | 450 |
| 29 | 40 | 157 | 142 | 285 | 171 | 413 | 542 |
| 30 | 68 | 158 | 530 | 286 | 776 | 414 | 334 |
| 31 | 130 | 159 | 321 | 287 | 330 | 415 | 233 |
| 32 | 19 | 160 | 31 | 288 | 226 | 416 | 555 |
| 33 | 13 | 161 | 200 | 289 | 549 | 417 | 774 |
| 34 | 48 | 162 | 90 | 290 | 538 | 418 | 175 |
| 35 | 14 | 163 | 545 | 291 | 387 | 419 | 123 |
| 36 | 72 | 164 | 292 | 292 | 308 | 420 | 658 |
| 37 | 257 | 165 | 322 | 293 | 216 | 421 | 612 |
| 38 | 21 | 166 | 532 | 294 | 416 | 422 | 341 |
| 39 | 132 | 167 | 263 | 295 | 271 | 423 | 777 |
| 40 | 35 | 168 | 149 | 296 | 279 | 424 | 220 |
| 41 | 258 | 169 | 102 | 297 | 158 | 425 | 314 |
| 42 | 26 | 170 | 105 | 298 | 337 | 426 | 424 |
| 43 | 513 | 171 | 304 | 299 | 550 | 427 | 395 |
| 44 | 80 | 172 | 296 | 300 | 672 | 428 | 673 |
| 45 | 37 | 173 | 163 | 301 | 118 | 429 | 583 |
| 46 | 25 | 174 | 92 | 302 | 332 | 430 | 355 |
| 47 | 22 | 175 | 47 | 303 | 579 | 431 | 287 |
| 48 | 136 | 176 | 267 | 304 | 540 | 432 | 183 |
| 49 | 260 | 177 | 385 | 305 | 389 | 433 | 234 |
| 50 | 264 | 178 | 546 | 306 | 173 | 434 | 125 |
| 51 | 38 | 179 | 324 | 307 | 121 | 435 | 557 |
| 52 | 514 | 180 | 208 | 308 | 553 | 436 | 660 |
| 53 | 96 | 181 | 386 | 309 | 199 | 437 | 616 |
| 54 | 67 | 182 | 150 | 310 | 784 | 438 | 342 |
| 55 | 41 | 183 | 153 | 311 | 179 | 439 | 316 |
| 56 | 144 | 184 | 165 | 312 | 228 | 440 | 241 |
| 57 | 28 | 185 | 106 | 313 | 338 | 441 | 778 |
| 58 | 69 | 186 | 55 | 314 | 312 | 442 | 563 |
| 59 | 42 | 187 | 328 | 315 | 704 | 443 | 345 |
| 60 | 516 | 188 | 536 | 316 | 390 | 444 | 452 |
| 61 | 49 | 189 | 577 | 317 | 174 | 445 | 397 |
| 62 | 74 | 190 | 548 | 318 | 554 | 446 | 403 |
| 63 | 272 | 191 | 113 | 319 | 581 | 447 | 207 |
| 64 | 160 | 192 | 154 | 320 | 393 | 448 | 674 |
| 65 | 520 | 193 | 79 | 321 | 283 | 449 | 558 |
| 66 | 288 | 194 | 269 | 322 | 122 | 450 | 785 |
| 67 | 528 | 195 | 108 | 323 | 448 | 451 | 432 |
| 68 | 192 | 196 | 578 | 324 | 353 | 452 | 357 |
| 69 | 544 | 197 | 224 | 325 | 561 | 453 | 187 |
| 70 | 70 | 198 | 166 | 326 | 203 | 454 | 236 |
| 71 | 44 | 199 | 519 | 327 | 63 | 455 | 664 |
| 72 | 131 | 200 | 552 | 328 | 340 | 456 | 624 |
| 73 | 81 | 201 | 195 | 329 | 394 | 457 | 587 |
| 74 | 50 | 202 | 270 | 330 | 527 | 458 | 780 |
| 75 | 73 | 203 | 641 | 331 | 582 | 459 | 705 |
| 76 | 15 | 204 | 523 | 332 | 556 | 460 | 126 |
| 77 | 320 | 205 | 275 | 333 | 181 | 461 | 242 |
| 78 | 133 | 206 | 580 | 334 | 295 | 462 | 565 |
| 79 | 52 | 207 | 291 | 335 | 285 | 463 | 398 |
| 80 | 23 | 208 | 59 | 336 | 232 | 464 | 346 |
| 81 | 134 | 209 | 169 | 337 | 124 | 465 | 456 |
| 82 | 384 | 210 | 560 | 338 | 205 | 466 | 358 |
| 83 | 76 | 211 | 114 | 339 | 182 | 467 | 405 |
| 84 | 137 | 212 | 277 | 340 | 643 | 468 | 303 |
| 85 | 82 | 213 | 156 | 341 | 562 | 469 | 569 |
| 86 | 56 | 214 | 87 | 342 | 286 | 470 | 244 |
| 87 | 27 | 215 | 197 | 343 | 585 | 471 | 595 |
| 88 | 97 | 216 | 116 | 344 | 299 | 472 | 189 |
| 89 | 39 | 217 | 170 | 345 | 354 | 473 | 566 |
| 90 | 259 | 218 | 61 | 346 | 211 | 474 | 676 |
| 91 | 84 | 219 | 531 | 347 | 401 | 475 | 361 |
| 92 | 138 | 220 | 525 | 348 | 185 | 476 | 706 |
| 93 | 145 | 221 | 642 | 349 | 396 | 477 | 589 |
| 94 | 261 | 222 | 281 | 350 | 344 | 478 | 215 |
| 95 | 29 | 223 | 278 | 351 | 586 | 479 | 786 |
| 96 | 43 | 224 | 526 | 352 | 645 | 480 | 647 |
| 97 | 98 | 225 | 177 | 353 | 593 | 481 | 348 |
| 98 | 515 | 226 | 293 | 354 | 535 | 482 | 419 |
| 99 | 88 | 227 | 388 | 355 | 240 | 483 | 406 |
| 100 | 140 | 228 | 91 | 356 | 206 | 484 | 464 |
| 101 | 30 | 229 | 584 | 357 | 95 | 485 | 680 |
| 102 | 146 | 230 | 769 | 358 | 327 | 486 | 801 |
| 103 | 71 | 231 | 198 | 359 | 564 | 487 | 362 |
| 104 | 262 | 232 | 172 | 360 | 800 | 488 | 590 |
| 105 | 265 | 233 | 120 | 361 | 402 | 489 | 409 |
| 106 | 161 | 234 | 201 | 362 | 356 | 490 | 570 |
| 107 | 576 | 235 | 336 | 363 | 307 | 491 | 788 |
| 108 | 45 | 236 | 62 | 364 | 301 | 492 | 597 |
| 109 | 100 | 237 | 282 | 365 | 417 | 493 | 572 |
| 110 | 640 | 238 | 143 | 366 | 213 | 494 | 219 |
| 111 | 51 | 239 | 103 | 367 | 568 | 495 | 311 |
| 112 | 148 | 240 | 178 | 368 | 832 | 496 | 708 |
| 113 | 46 | 241 | 294 | 369 | 588 | 497 | 598 |
| 114 | 75 | 242 | 93 | 370 | 186 | 498 | 601 |
| 115 | 266 | 243 | 644 | 371 | 646 | 499 | 651 |
| 116 | 273 | 244 | 202 | 372 | 404 | 500 | 421 |
| 117 | 517 | 245 | 592 | 373 | 227 | 501 | 792 |
| 118 | 104 | 246 | 323 | 374 | 896 | 502 | 802 |
| 119 | 162 | 247 | 392 | 375 | 594 | 503 | 611 |
| 120 | 53 | 248 | 297 | 376 | 418 | 504 | 602 |
| 121 | 193 | 249 | 770 | 377 | 302 | 505 | 410 |
| 122 | 152 | 250 | 107 | 378 | 649 | 506 | 231 |
| 123 | 77 | 251 | 180 | 379 | 771 | 507 | 688 |
| 124 | 164 | 252 | 151 | 380 | 360 | 508 | 653 |
| 125 | 768 | 253 | 209 | 381 | 539 | 509 | 248 |
| 126 | 268 | 254 | 284 | 382 | 111 | 510 | 369 |
| 127 | 274 | 255 | 648 | 383 | 331 | 511 | 190 |

| $W ( {Q}_{i}^{{N}_{max}} )$ | $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ | $W ( {Q}_{i}^{{N}_{max}} )$ | ${Q}_{i}^{{N}_{max}}$ |
|---|---|---|---|---|---|---|---|---|
| 0 | 512 | 364 | 640 | 414 | 768 | 819 | 896 | 966 |
| 1 | 513 | 654 | 641 | 223 | 769 | 814 | 897 | 755 |
| 2 | 514 | 659 | 642 | 663 | 770 | 439 | 898 | 859 |
| 3 | 515 | 335 | 643 | 692 | 771 | 929 | 899 | 940 |
| 4 | 516 | 480 | 644 | 835 | 772 | 490 | 900 | 830 |
| 5 | 517 | 315 | 645 | 619 | 773 | 623 | 901 | 911 |
| 6 | 518 | 221 | 646 | 472 | 774 | 671 | 902 | 871 |
| 7 | 519 | 370 | 647 | 455 | 775 | 739 | 903 | 639 |
| 8 | 520 | 613 | 648 | 796 | 776 | 916 | 904 | 888 |
| 9 | 521 | 422 | 649 | 809 | 777 | 463 | 905 | 479 |
| 10 | 522 | 425 | 650 | 714 | 778 | 843 | 906 | 946 |
| 11 | 523 | 451 | 651 | 721 | 779 | 381 | 907 | 750 |
| 12 | 524 | 614 | 652 | 837 | 780 | 497 | 908 | 969 |
| 13 | 525 | 543 | 653 | 716 | 781 | 930 | 909 | 508 |
| 14 | 526 | 235 | 654 | 864 | 782 | 821 | 910 | 861 |
| 15 | 527 | 412 | 655 | 810 | 783 | 726 | 911 | 757 |
| 16 | 528 | 343 | 656 | 606 | 784 | 961 | 912 | 970 |
| 17 | 529 | 372 | 657 | 1912 | 785 | 872 | 913 | 919 |
| 18 | 530 | 775 | 658 | 722 | 786 | 492 | 914 | 875 |
| 19 | 531 | 317 | 659 | 696 | 787 | 631 | 915 | 862 |
| 20 | 532 | 222 | 660 | 377 | 788 | 729 | 916 | 758 |
| 21 | 533 | 426 | 661 | 435 | 789 | 700 | 917 | 948 |
| 22 | 534 | 453 | 662 | 817 | 790 | 443 | 918 | 977 |
| 23 | 535 | 237 | 663 | 319 | 791 | 741 | 919 | 923 |
| 24 | 536 | 559 | 664 | 621 | 792 | 845 | 920 | 972 |
| 25 | 537 | 833 | 665 | 812 | 793 | 920 | 921 | 761 |
| 26 | 538 | 804 | 666 | 484 | 794 | 382 | 922 | 877 |
| 27 | 539 | 712 | 667 | 430 | 795 | 822 | 923 | 952 |
| 28 | 540 | 834 | 668 | 838 | 796 | 851 | 924 | 495 |
| 29 | 541 | 661 | 669 | 667 | 797 | 730 | 925 | 703 |
| 30 | 542 | 808 | 670 | 488 | 798 | 498 | 926 | 935 |
| 31 | 543 | 779 | 671 | 239 | 799 | 880 | 927 | 978 |
| 32 | 544 | 617 | 672 | 378 | 800 | 742 | 928 | 883 |
| 33 | 545 | 604 | 673 | 459 | 801 | 445 | 929 | 762 |
| 34 | 546 | 433 | 674 | 622 | 802 | 471 | 930 | 503 |
| 35 | 547 | 720 | 675 | 627 | 803 | 635 | 931 | 925 |
| 36 | 548 | 816 | 676 | 437 | 804 | 932 | 932 | 878 |
| 37 | 549 | 836 | 677 | 380 | 805 | 687 | 933 | 735 |
| 38 | 550 | 347 | 678 | 818 | 806 | 903 | 934 | 993 |
| 39 | 551 | 897 | 679 | 461 | 807 | 825 | 935 | 885 |
| 40 | 552 | 243 | 680 | 496 | 808 | 500 | 936 | 939 |
| 41 | 553 | 662 | 681 | 669 | 809 | 846 | 937 | 994 |
| 42 | 554 | 454 | 682 | 679 | 810 | 745 | 938 | 980 |
| 43 | 555 | 318 | 683 | 724 | 811 | 826 | 939 | 926 |
| 44 | 556 | 675 | 684 | 841 | 812 | 732 | 940 | 764 |
| 45 | 557 | 618 | 685 | 629 | 813 | 446 | 941 | 941 |
| 46 | 558 | 898 | 686 | 351 | 814 | 962 | 942 | 967 |
| 47 | 559 | 781 | 687 | 467 | 815 | 936 | 943 | 886 |
| 48 | 560 | 376 | 688 | 438 | 816 | 475 | 944 | 831 |
| 49 | 561 | 428 | 689 | 737 | 817 | 853 | 945 | 947 |
| 50 | 562 | 665 | 690 | 251 | 818 | 867 | 946 | 507 |
| 51 | 563 | 736 | 691 | 462 | 819 | 637 | 947 | 889 |
| 52 | 564 | 567 | 692 | 442 | 820 | 907 | 948 | 984 |
| 53 | 565 | 840 | 693 | 441 | 821 | 487 | 949 | 751 |
| 54 | 566 | 625 | 694 | 469 | 822 | 695 | 950 | 942 |
| 55 | 567 | 238 | 695 | 247 | 823 | 746 | 951 | 996 |
| 56 | 568 | 359 | 696 | 683 | 824 | 828 | 952 | 971 |
| 57 | 569 | 457 | 697 | 842 | 825 | 753 | 953 | 890 |
| 58 | 570 | 399 | 698 | 738 | 826 | 854 | 954 | 509 |
| 59 | 571 | 787 | 699 | 899 | 827 | 857 | 955 | 949 |
| 60 | 572 | 591 | 700 | 670 | 828 | 504 | 956 | 973 |
| 61 | 573 | 678 | 701 | 783 | 829 | 799 | 957 | 1000 |
| 62 | 574 | 434 | 702 | 849 | 830 | 255 | 958 | 892 |
| 63 | 575 | 677 | 703 | 820 | 831 | 964 | 959 | 950 |
| 64 | 576 | 349 | 704 | 728 | 832 | 909 | 960 | 863 |
| 65 | 577 | 245 | 705 | 928 | 833 | 719 | 961 | 759 |
| 66 | 578 | 458 | 706 | 791 | 834 | 477 | 962 | 1008 |
| 67 | 579 | 666 | 707 | 367 | 835 | 915 | 963 | 510 |
| 68 | 580 | 620 | 708 | 901 | 836 | 638 | 964 | 979 |
| 69 | 581 | 363 | 709 | 630 | 837 | 748 | 965 | 953 |
| 70 | 582 | 127 | 710 | 685 | 838 | 944 | 966 | 763 |
| 71 | 583 | 191 | 711 | 844 | 839 | 869 | 967 | 974 |
| 72 | 584 | 782 | 712 | 633 | 840 | 491 | 968 | 954 |
| 73 | 585 | 407 | 713 | 711 | 841 | 699 | 969 | 879 |
| 74 | 586 | 436 | 714 | 253 | 842 | 754 | 970 | 981 |
| 75 | 587 | 626 | 715 | 691 | 843 | 858 | 971 | 982 |
| 76 | 588 | 571 | 716 | 824 | 844 | 478 | 972 | 927 |
| 77 | 589 | 465 | 717 | 902 | 845 | 968 | 973 | 995 |
| 78 | 590 | 681 | 718 | 686 | 846 | 383 | 974 | 765 |
| 79 | 591 | 246 | 719 | 740 | 847 | 910 | 975 | 956 |
| 80 | 592 | 707 | 720 | 850 | 848 | 815 | 976 | 887 |
| 81 | 593 | 350 | 721 | 375 | 849 | 976 | 977 | 985 |
| 82 | 594 | 599 | 722 | 444 | 850 | 870 | 978 | 997 |
| 83 | 595 | 668 | 723 | 470 | 851 | 917 | 979 | 986 |
| 84 | 596 | 790 | 724 | 483 | 852 | 727 | 980 | 943 |
| 85 | 597 | 460 | 725 | 415 | 853 | 493 | 981 | 891 |
| 86 | 598 | 249 | 726 | 485 | 854 | 873 | 982 | 998 |
| 87 | 599 | 682 | 727 | 905 | 855 | 701 | 983 | 766 |
| 88 | 600 | 573 | 728 | 795 | 856 | 931 | 984 | 511 |
| 89 | 601 | 411 | 729 | 473 | 857 | 756 | 985 | 988 |
| 90 | 602 | 803 | 730 | 634 | 858 | 860 | 986 | 1001 |
| 91 | 603 | 789 | 731 | 744 | 859 | 499 | 987 | 951 |
| 92 | 604 | 709 | 732 | 852 | 860 | 731 | 988 | 1002 |
| 93 | 605 | 365 | 733 | 960 | 861 | 823 | 989 | 893 |
| 94 | 606 | 440 | 734 | 865 | 862 | 922 | 990 | 975 |
| 95 | 607 | 628 | 735 | 693 | 863 | 874 | 991 | 894 |
| 96 | 608 | 689 | 736 | 797 | 864 | 918 | 992 | 1009 |
| 97 | 609 | 374 | 737 | 906 | 865 | 502 | 993 | 955 |
| 98 | 610 | 423 | 738 | 715 | 866 | 933 | 994 | 1004 |
| 99 | 611 | 466 | 739 | 807 | 867 | 743 | 995 | 1010 |
| 100 | 612 | 793 | 740 | 474 | 868 | 760 | 996 | 957 |
| 101 | 613 | 250 | 741 | 636 | 869 | 881 | 997 | 983 |
| 102 | 614 | 371 | 742 | 694 | 870 | 494 | 998 | 958 |
| 103 | 615 | 481 | 743 | 254 | 871 | 702 | 999 | 987 |
| 104 | 616 | 574 | 744 | 717 | 872 | 921 | 1000 | 1012 |
| 105 | 617 | 413 | 745 | 575 | 873 | 501 | 1001 | 999 |
| 106 | 618 | 603 | 746 | 913 | 874 | 876 | 1002 | 1016 |
| 107 | 619 | 366 | 747 | 798 | 875 | 847 | 1003 | 767 |
| 108 | 620 | 468 | 748 | 811 | 876 | 992 | 1004 | 989 |
| 109 | 621 | 655 | 749 | 379 | 877 | 447 | 1005 | 1003 |
| 110 | 622 | 900 | 750 | 697 | 878 | 733 | 1006 | 990 |
| 111 | 623 | 805 | 751 | 431 | 879 | 827 | 1007 | 1005 |
| 112 | 624 | 615 | 752 | 607 | 880 | 934 | 1008 | 959 |
| 113 | 625 | 684 | 753 | 489 | 881 | 882 | 1009 | 1011 |
| 114 | 626 | 710 | 754 | 866 | 882 | 937 | 1010 | 1013 |
| 115 | 627 | 429 | 755 | 723 | 883 | 963 | 1011 | 895 |
| 116 | 628 | 794 | 756 | 486 | 884 | 747 | 1012 | 1006 |
| 117 | 629 | 252 | 757 | 908 | 885 | 505 | 1013 | 1014 |
| 118 | 630 | 373 | 758 | 718 | 886 | 855 | 1014 | 1017 |
| 119 | 631 | 605 | 759 | 813 | 887 | 924 | 1015 | 1018 |
| 120 | 632 | 848 | 760 | 476 | 888 | 734 | 1016 | 991 |
| 121 | 633 | 690 | 761 | 856 | 889 | 829 | 1017 | 1020 |
| 122 | 634 | 713 | 762 | 839 | 890 | 965 | 1018 | 1007 |
| 123 | 635 | 632 | 763 | 725 | 891 | 938 | 1019 | 1015 |
| 124 | 636 | 482 | 764 | 698 | 892 | 884 | 1020 | 1019 |
| 125 | 637 | 806 | 765 | 914 | 893 | 506 | 1021 | 1021 |
| 126 | 638 | 427 | 766 | 752 | 894 | 749 | 1022 | 1022 |
| 127 | 639 | 904 | 767 | 868 | 895 | 945 | 1023 | 1023 |

FIG. 19 illustrates an example LDPC coding 1900 according to embodiments of the present disclosure. For example, the UE 116 of FIG. 3 can be configured to use the LDPC coding 1900. This example is for illustration only and other embodiments can be used without departing from the scope of the present disclosure.

For LDPC coding, as shown in FIG. 19, the K coded bits (or CW) comprises (a) N information bits and (2) K−N parity check bits. The MSBs of the coded bits have more error protection (hence, are more reliable) than LSBs, since they have more core and additional checks (shown as blue square in the figure). In one example, the mapping of information bits to coding bits, as proposed earlier in the disclosure, is according to the reliability order of the LDPC code, as specified in 5G NR specification TS 38.212.

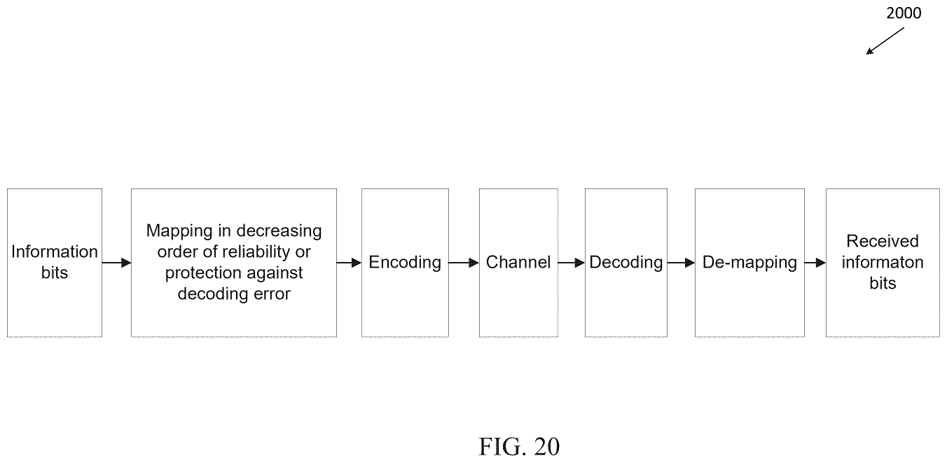

FIG. 20 illustrates an example bit processing chain 2000 according to embodiments of the present disclosure. For example, the bit processing chain 2000 can be implemented in the wireless network 100 of FIG. 1. This example is for illustration only and can be used without departing from the scope of the present disclosure.

In one embodiment, as shown in FIG. 20, the mapping and de-mapping blocks (shown in red) are included in the bit processing chain of a communication system. The information about the mapping can be according to at least one of the following examples.
In one example, both the mapping and de-mapping procedures are fixed (hence specified) in the specification.
In one example, both the mapping and de-mapping procedures are configured to the UE. This configuration can be via RRC or/and MACE CE or/and DCI. Or, this configuration can be via a system information message (e.g., SIB1).
In one example, the mapping procedure is fixed (hence specified) in the specification, and the de-mapping is configured to the UE. This configuration can be via RRC or/and MACE CE or/and DCI. Or, this configuration can be via a system information message (e.g., SIB1).
In one example, the de-mapping procedure is fixed (hence specified) in the specification, and the mapping is configured to the UE. This configuration can be via RRC or/and MACE CE or/and DCI. Or, this configuration can be via a system information message (e.g., SIB1).
In one example, the mapping and de-mapping procedures correspond to interleaving and de-interleaving procedures, respectively. Hence, an interleaver and a de-interleaver are included before encoding and after decoding blocks respectively. In one example, there can be an additional inter-leaver after encoding such that lower-order modulation bits are less reliable (than higher-order mod bits), hence are assigned/interleaved as MSBs before mapping to symbols.

In one embodiment, a segmentation procedure can be applied additionally, where the information bits are segmented into at least two segments. In one example, the number of segments is two for polar coding, and two or more for LDPC. The mapping of the information bits can also be across segments, in addition to coding bits.
In one example, the mapping order corresponds to MSBs of all segments followed by LSBs of all segments, i.e., MSB0 of segment 1, segment 2, . . . , MSB1 of segment 1, segment 2, . . . ), . . . . LSB of segment 1, segment 2, . . . ).
In one example, the mapping order corresponds to MSBs to LSBs of segment 1, MSBs to LSBs of segment 2, and so on.
In one example, the mapping order is fixed (hence specified) in the specification.
In one example, the mapping order is configured to the UE. This configuration can be via RRC or/and MACE CE or/and DCI. Or, this configuration can be via a system information message (e.g., SIB1).

In one embodiment, when there are multiple CWs,
In one example, the mapping order is the same/common/identical for all CWs.
In one example, the mapping order is different/independent for (or specific per) each CW.

In one embodiment, the unequal error protection as described earlier applies to UCI only or data only or both UCI and data. When it applies to both, the mapping can be joint or together by treating UCI bits and data bits together as information bits.
In one example, UCI transport block (TB) and data TB are coded together. In one example, the data TB comes from higher layer (above PHY), and the higher layer provides relevant info (e.g., distribution, priority etc.) for example, in a header of the TB, for the PHY layer to exploit it.
In one example, decoding of the UCI bits is preferred to be faster than that of the data, hence a separate coding for the two can be used.
In one example, when UCI and data are jointly channel coded, UCI bits can be placed in the beginning, hence proving more protection to UCI bits and less to data bits while coding. Besides, the decoding latency can be reduced if the UCI bits are in the beginning.
In one example, when the UCI part two parts, and UCI part 1 and part 2 have different protection (e.g., part 1 has more protection than part 2),
In one example, UCI part 1 can be coded separately, and UCI part 2 can be multiplexed with data and both can be coded jointly. In one example, this can happen based on UCI payload is greater or equal to a threshold (e.g., when UCI includes CSI or when CSI payload greater or equal to a threshold).

In one embodiment, the unequal error protection as described earlier applies at the parameter level. For example, a UCI parameter (e.g., RI/CQI) can be mapped such that it is more reliable than other UCI parameters (e.g., PMI).

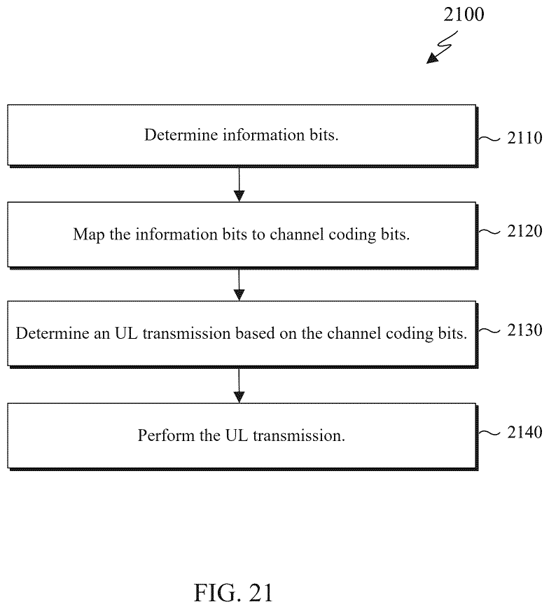

FIG. 21 illustrates an example method 2100 performed by a UE in a wireless communication system according to embodiments of the present disclosure. The method 2100 of FIG. 21 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2100 is for illustration only and other embodiments can be used without departing from the scope of the present disclosure.

The method 2100 begins with the UE determining information bits (2110). In various embodiments, the information bits include at least one of UCI and UL data and the UCI includes at least one of CSI, a HARQ-ACK, and a SR. In various embodiments, the information bits include a sequence of blocks B₀B₁ . . . , where an i-th block Bᵢ includes Nᵢ consecutive bits from the information bits, where Nᵢ≥1.

The UE then maps the information bits to channel coding bits (2120). For example, in 2120, the mapping of the information bits to the channel coding bits is based on a distribution of the information bits and a reliability of the channel coding bits. In various embodiments, the reliability is determined based on a protection level against a decoding error. In various embodiments, the mapping is fixed or configured via higher layer.

In various embodiments, a more probable block of the sequence of blocks is mapped to a more reliable portion of the channel coding bits as compared with a less probable block of the sequence of blocks and a less reliable portion of the channel coding bits and a portion of the channel coding bits includes at least one bit of the channel coding bits. In some examples, the more probable block is determined based on the distribution of the information bits. In some examples, the more reliable portion of the channel coding bits is included in MSBs of the channel coding bits.

The UE then determines an UL transmission based on the channel coding bits (2130). The UE then performs the UL transmission (2140).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a processor configured to:
determine information bits,
map the information bits to channel coding bits, and
determine an uplink (UL) transmission based on the channel coding bits; and
a transceiver operably coupled to the processor, the transceiver configured to perform the UL transmission,
wherein the mapping of the information bits to the channel coding bits is based on (i) a distribution of the information bits and (ii) a reliability of the channel coding bits.

2. The UE of claim 1, wherein:
the information bits include at least one of UL control information (UCI) and UL data, and
the UCI includes at least one of channel state information (CSI), a hybrid automatic request repeat acknowledgement (HARQ-ACK), and a scheduling request (SR).

3. The UE of claim 1, wherein the information bits include a sequence of blocks B₀B₁ . . . , where an i-th block Bᵢ includes Nᵢ consecutive bits from the information bits, where Nᵢ≥1.

4. The UE of claim 3, wherein:
a more probable block of the sequence of blocks is mapped to a more reliable portion of the channel coding bits as compared with a less probable block of the sequence of blocks and a less reliable portion of the channel coding bits, and
a portion of the channel coding bits includes at least one bit of the channel coding bits.

5. The UE of claim 4, wherein the more probable block is determined based on the distribution of the information bits.

6. The UE of claim 4, wherein the more reliable portion of the channel coding bits is included in most significant bits (MSBs) of the channel coding bits.

7. The UE of claim 1, wherein the reliability is determined based on a protection level against a decoding error.

8. The UE of claim 1, wherein the mapping is fixed or configured via higher layer.

9. A base station (BS), comprising:
a transceiver configured to receive an uplink (UL) transmission; and
a processor operably coupled to the transceiver, the processor configured to determine information bits based on channel coding bits included in the UL transmission,
wherein mapping of the information bits to the channel coding bits is based on (i) a distribution of the information bits and (ii) a reliability of the channel coding bits.

10. The BS of claim 9, wherein:
the information bits include at least one of UL control information (UCI) and UL data, and
the UCI includes at least one of channel state information (CSI), a hybrid automatic request repeat acknowledgement (HARQ-ACK), and a scheduling request (SR).

11. The BS of claim 9, wherein the information bits include a sequence of blocks B₀B₁ . . . , where an i-th block Bᵢ includes Nᵢ consecutive bits from the information bits, where Nᵢ≥1.

12. The BS of claim 11, wherein:
a more probable block of the sequence of blocks is mapped to a more reliable portion of the channel coding bits as compared with a less probable block of the sequence of blocks and a less reliable portion of the channel coding bits, and
a portion of the channel coding bits includes at least one bit of the channel coding bits.

13. The BS of claim 12, wherein the more probable block is determined based on the distribution of the information bits.

14. The BS of claim 12, wherein the more reliable portion of the channel coding bits is included in most significant bits (MSBs) of the channel coding bits.

15. The BS of claim 9, wherein the reliability is determined based on a protection level against a decoding error.

16. The BS of claim 9, wherein the mapping is fixed or configured via higher layer.

17. A method performed by a user equipment (UE), the method comprising:
determining information bits;
mapping the information bits to channel coding bits;
determining an uplink (UL) transmission based on the channel coding bits; and
performing the UL transmission,
wherein the mapping of the information bits to the channel coding bits is based on (i) a distribution of the information bits and (ii) a reliability of the channel coding bits.

18. The method of claim 17, wherein:
the information bits include at least one of UL control information (UCI) and UL data, and
the UCI includes at least one of channel state information (CSI), a hybrid automatic request repeat acknowledgement (HARQ-ACK), and a scheduling request (SR).

19. The method of claim 17, wherein the information bits include a sequence of blocks B₀B₁ . . . , where an i-th block Bᵢ includes Nᵢ consecutive bits from the information bits, where Nᵢ≥1.

20. The method of claim 19, wherein:
a more probable block of the sequence of blocks is mapped to a more reliable portion of the channel coding bits as compared with a less probable block of the sequence of blocks and a less reliable portion of the channel coding bits, and
a portion of the channel coding bits includes at least one bit of the channel coding bits.
